(19) United States
(12) Patent Application Publication
(10) Pub. No.: US 2026/0273569 A1
(43) Pub. Date: Sep. 17, 2026

(54) COATING DEVICE AND METHOD FOR POSITIONING DIE HEAD THEREOF

(71) Applicant: SHENZHEN YINGHE TECHNOLOGY CO.,LTD., Shenzhen (CN)

(72) Inventors: Deqiang YIN, Guangdong (CN); Xiaoqiang WANG, Shenzhen (CN); Banghua LONG, Shenzhen (CN)

(21) Appl. No.: 19/654,247

(22) Filed: Apr. 21, 2026

Related U.S. Application Data
(63) Continuation of application No. PCT/CN2025/139832, filed on Dec. 3, 2025.

(30) Foreign Application Priority Data
Mar. 17, 2025 (CN) 202510309406.6

(51) Int. Cl. B05C 5/02; G05B 19/404

(52) U.S. Cl. CPC B05C 5/0254; G05B 19/404; G05B 2219/34216; G05B 2219/45013

(57) ABSTRACT

The present application discloses a coating device and a method for positioning a die head thereof. The method includes: acquiring a calibrated displacement corresponding to a die head when the die head moves to a first position; acquiring a real-time displacement of the die head when a driving mechanism drives the die head to move to a second position according to a preset spacing; monitoring, in real time, motion parameters of a servo motor using a built-in encoder within the driving mechanism; determining the real-time displacement as the difference between the calibrated displacement and the current displacement of the die head as measured by an external encoder; and, if the real-time displacement matches the preset spacing, determining that the die head is positioned at the target position.

### CROSS REFERENCE TO RELATED APPLICATION

The present application is a continuation application of an international application PCT/CN2025/139832, filed on December 03, 2025, and claims priority to Chinese Patent Application No. 202510309406.6, filed on March 17, 2025, the entire contents of which are incorporated herein by reference.

### TECHNICAL FIELD

The present application relates to the technical field of die head positioning, and more particularly to a coating device and a method for positioning a die head thereof.

### BACKGROUND

In the manufacturing of lithium-ion batteries, the electrode coating process typically involves using a coating machine to apply a prepared slurry onto the positive or negative electrode sheets. In this process, the thickness of the slurry coated onto the electrode sheets must exhibit high consistency; the die head of the coating machine is the component directly responsible for applying the slurry, and the longitudinal control of the die head is critical to the quality of the coating result. Longitudinal control of the die head refers to the control of parameters, such as coating precision and thickness uniformity, along the length direction of the electrode sheet during the coating process. Only through precise longitudinal control of the die head can the thickness uniformity of the entire coating layer be ensured, and can the thickness and shape of the coating be adjusted according to specific process requirements.

In the relevant prior art, the core of longitudinal control of the die head lies in controlling the positioning accuracy of the die head. Currently, a common positioning scheme involves detecting and determining the position of the die head using a single linear encoder. On one hand, linear encoders are prone to the accumulation of data errors, that is, the measured position information is not entirely precise, and the operator is compelled to perform frequent calibrations in an attempt to correct these errors. Such repetitive calibration procedures may, paradoxically, lead to an ever-widening discrepancy between the actual position of the die head and the measured position of the linear encoder. On the other hand, when the coating machine experiences a power outage and is subsequently powered back on, the linear encoder, which relies on counting pulses to determine the position of the die head , cannot retain the absolute position prior to the outage. If the die head shifts during the power outage, the position information recorded by the linear encoder after power is restored will no longer be accurate. These issues compromise the positioning accuracy of the die head, and it is impossible to precisely control the thickness of the slurry coated on the electrode sheet, ultimately affecting the quality of the finished battery and resulting in unnecessary production waste.

### SUMMARY

In view of the foregoing, the present application provides a coating device and a method for positioning a die head thereof, capable of achieving rapid and precise positioning of the die head, so as to ensure the convenience and reliability of position control of the die head, and thereby ensuring the consistency of the slurry coating effect.

In a first aspect, the present application provides a die head positioning method for a coating device, including:

acquiring a calibrated displacement corresponding to a die head when the die head moves to a first position;

acquiring a real-time displacement of the die head when a driving mechanism drives the die head to move to a second position according to a preset spacing; in which a built-in encoder within the driving mechanism monitors motion parameters of a servo motor in real time; and the real-time displacement is a difference between the calibrated displacement and a current displacement of the die head measured by an external encoder; and

determining that the die head is positioned at a target position if the real-time displacement matches the preset spacing.

In some embodiments, the calibrated displacement is defined as L = W + S; W is an initial displacement measured by the external encoder when the die head is at the first position, and S is an initial spacing between a coating lip of the die head and a roller body.

In some embodiments, the method further includes:

continuely driving, through the driving mechanism, the die head to move based on the difference between the real-time displacement and the preset spacing when the real-time displacement does not match the preset spacing, until the die head is positioned at the target position.

In some embodiments, the real-time displacement is determined to be matched with the preset spacing when a deviation between the real-time displacement and the preset spacing falls within a preset range.

In a second aspect of the present application, a coating device is provided, which includes a coating mechanism, a control module, a driving mechanism, and a monitoring assembly:

the coating mechanism includes a die head, the die head is configured to apply a slurry, and the die head is positioned to a target position based on the die head positioning method according to the first aspect;

the control module is configured to transmit a motion command to the driving mechanism based on a received preset spacing, and to receive monitoring data transmitted by the monitoring assembly;

the driving mechanism includes a servo motor, a lead screw assembly, and a built-in encoder; the servo motor is configured to drive the lead screw assembly according to the motion command, the lead screw assembly is configured to drive the coating mechanism to move reciprocally, and the built-in encoder monitors a motion parameter of the servo motor and feeds the motion parameter back to the control module; and

the monitoring assembly includes an external encoder, configured to generate the monitoring data, the monitoring data includes a calibrated displacement and a real-time displacement of the die head.

In some embodiments, the external encoder is in communication with the control module.

In some embodiments, the monitoring assembly further includes a limiter, the limiter is configured to monitor a movement range of a transmission component within the driving mechanism.

In some embodiments, the built-in encoder is a rotary encoder, and the external encoder is a linear encoder.

In some embodiments, the coating device further includes a human-machine interface, configured to display the real-time displacement and to set the preset spacing.

In a third aspect of the present application provides a computer program product including a computer program, the computer program is configured to execute the die head positioning method for a coating device as described in the first aspect.

The technical solutions provided by the present application can include the following beneficial effects:

The coating device of the present application operates based on the collaborative interaction among the control module, the driving mechanism, the coating mechanism, and the monitoring assembly. Specifically, the absolute position memory of the built-in encoder and the absolute position memory of the external encoder perform mutual verification; this dual-encoder system significantly enhances the reliability of the die head positioning. Such a design enables precise positioning of the die head prior to slurry coating, thereby ensuring that the spacing between the coating lip of the die head and the roller body meets the requirements for the desired slurry coating thickness.

The die head positioning method of the present application employs a dual-encoder system. This system calculates position using a built-in encoder embedded within the driving mechanism, such as an encoder integrated into a servo motor, and subsequently utilizes an external encoder (e.g., a linear encoder) as an auxiliary reference to achieve precise positioning of the die head. This dual-verification mechanism enhances the accuracy and reliability of the longitudinal position control for the die head.

The foregoing description serves merely as a summary of the technical solution proposed in the present application. In order to facilitate a clearer understanding of the technical means employed herein, the solution may be implemented according to the detailed content of this specification. Furthermore, in order to render the aforementioned and other objectives, features, and advantages of the present application more apparent and comprehensible, specific embodiments of the present application are set forth below.

### BRIEF DESCRIPTION OF THE DRAWINGS

In order to more clearly illustrate the technical solutions embodied in the embodiments of the present application, the accompanying drawings required for describing said embodiments or the prior art are briefly introduced below. It is to be understood that the drawings described below depict merely certain embodiments of the present application; for a person of ordinary skill in the art, other drawings may be derived from these drawings without the exercise of inventive labor.

FIG. 1 is a side view of a simplified structure of a coating device, illustrating an embodiment of the present application;

FIG. 2 is a schematic diagram of modules of a coating device, illustrating an embodiment of the present application;

FIG. 3 is a perspective view of a coating device, illustrating an embodiment of the present application;

FIG. 4 is a side view of the coating device shown in FIG. 3;

FIG. 5 is a front view of the coating device shown in FIG. 3;

FIG. 6 is a top view of the coating device shown in FIG. 3;

FIG. 7 is a schematic flowchart of a die head positioning method for a coating device, illustrating an embodiment of the present application;

FIG. 8 is a schematic diagram of a human-machine interface for controlling a calibration of a die head of a coating device, illustrating an embodiment of the present application;

FIG. 9 is a schematic diagram of a human-machine interface for setting a preset spacing for a coating device, illustrating an embodiment of the present application;

FIG. 10 is another schematic flowchart of a die head positioning method for a coating device, illustrating an embodiment of the present application.

The meanings of reference signs in the figures are as follows:

coating mechanism 100; die head 110; roller body 120;

control module 200;

driving mechanism 300; servo motor 310; lead screw assembly 320; lead screw 321; upper slider 322; lower slider 323; built-in encoder 330; and

monitoring assembly 400; external encoder 410; limiter 420.

### DETAILED DESCRIPTION OF THE EMBODIMENTS

The embodiments of the technical solution of the present application will now be described in detail with reference to the accompanying drawings. The following embodiments are provided solely to more clearly illustrate the technical solution of the present application; therefore, they serve merely as examples and should not be construed as limiting the scope of protection of the present application.

Unless otherwise defined, all technical and scientific terms used herein have the same meaning as commonly understood by a person skilled in the technical field to which the present application pertains. The terminology used herein is for the purpose of describing specific embodiments only and is not intended to limit the present application. In the description, claims, and accompanying drawings of the present application, the terms "comprising" and "having", as well as any variations thereof, are intended to cover non-exclusive inclusion.

In the description of the embodiments of the present application, technical terms such as "first," "second," etc., are used solely to distinguish between different objects and should not be interpreted as indicating or implying relative importance, nor as implicitly indicating the quantity, specific sequence, or hierarchical relationship of the indicated technical features. In the description of the embodiments of the present application, the term "multiple" refers to two or more, unless otherwise explicitly and specifically defined.

Reference herein to an "embodiment" means that a particular feature, structure, or characteristic described in connection with the embodiment may be included in at least one embodiment of the present application. The appearance of this phrase in various places throughout the description does not necessarily refer to the same embodiment, nor are such embodiments necessarily mutually exclusive, independent, or alternative to other embodiments. Those skilled in the art will explicitly and implicitly understand that the embodiments described herein may be combined with other embodiments.

In the description of the embodiments of the present application, the term "and/or" serves merely to describe the associative relationship between associated objects, indicating that three possible relationships may exist. For example, "A and/or B" may represent any of the following three scenarios: A exists alone; both A and B exist simultaneously; or B exists alone. Furthermore, in this document, the character "/" generally indicates an "OR" relationship between the preceding and succeeding associated objects.

In the description of the embodiments of the present application, the term "multiple" refers to two or more (inclusive); similarly, "multiple sets" refers to two or more sets (inclusive), and "multiple pieces" refers to two or more pieces (inclusive).

In the description of the embodiments of the present application, technical terms such as "center," "longitudinal," "lateral," "length," "width," "thickness," "upper," "lower," "front," "rear," "left," "right," "vertical," "horizontal," "top," "bottom," "inner," "outer," "clockwise," "counter-clockwise," "axial," "radial," and "circumferential", which indicate orientation or positional relationships, are based on the orientations or positional relationships shown in the accompanying drawings. These terms are used solely to facilitate the description of the embodiments of the present application and to simplify the text; they are not intended to indicate or imply that the referred-to devices or elements must possess a specific orientation, or be constructed and operated in a specific orientation. Therefore, these terms should not be construed as limitations on the embodiments of the present application.

In the description of the embodiments of the present application, unless explicitly stated or defined otherwise, technical terms such as "mounting," "interconnecting," "connecting," and "fixing" should be interpreted broadly. For instance, a connection may be fixed or detachable, or the components may be formed integrally; it may be a mechanical connection or an electrical connection; it may be a direct connection or an indirect connection via an intermediate medium; or it may represent internal communication between two elements or an interactive relationship between two elements. For a person of ordinary skill in the art, the specific meanings of the aforementioned terms within the context of the embodiments of the present application can be understood based on the specific circumstances.

In the related art, when a coating device employs a linear encoder for die head positioning, since inaccuracies in the measurement values provided by the linear encoder often necessitate frequent calibration by operators in an attempt to correct the errors. However, such repetitive calibration may lead to an increasing discrepancy between the actual position of the die head and the position measured by the linear encoder, thereby compromising the positioning accuracy of the die head.

In order to address the aforementioned issues, the embodiments of the present application provide a coating device and a method for positioning a die head thereof that enable rapid and precise positioning of the die head. This ensures the convenience and reliability of position control of the die head, thereby ensuring the consistency of the slurry coating effect.

The technical solutions of the embodiments of the present application are described in detail below with reference to the accompanying drawings.

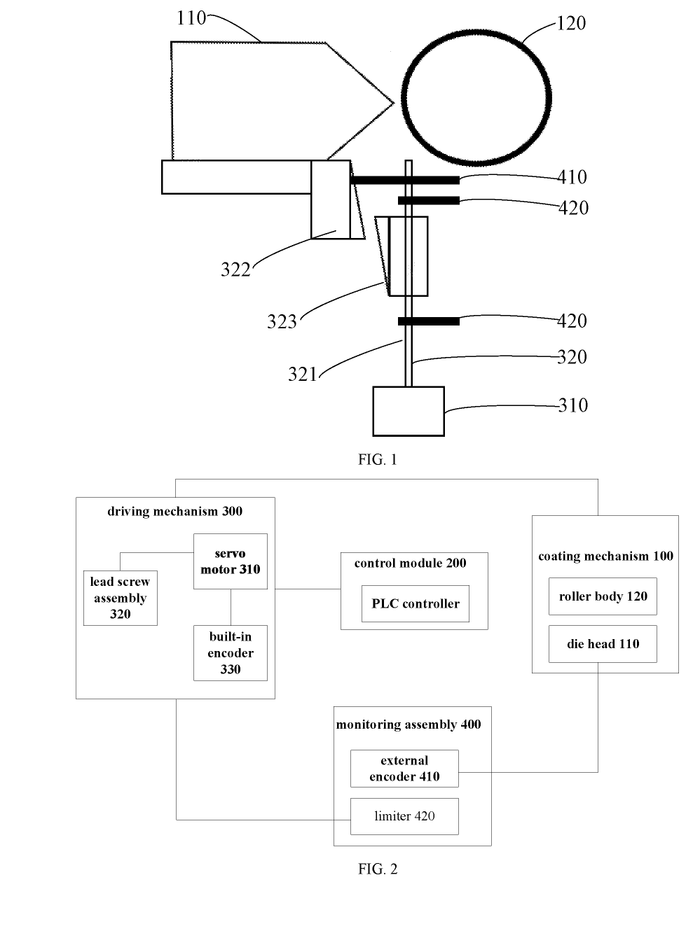

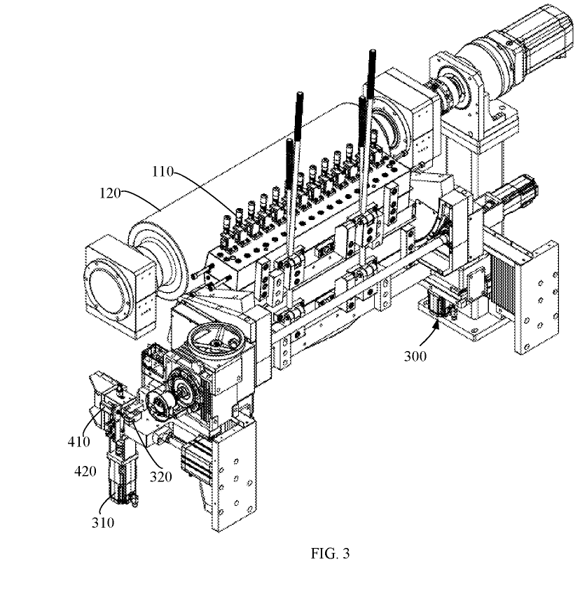

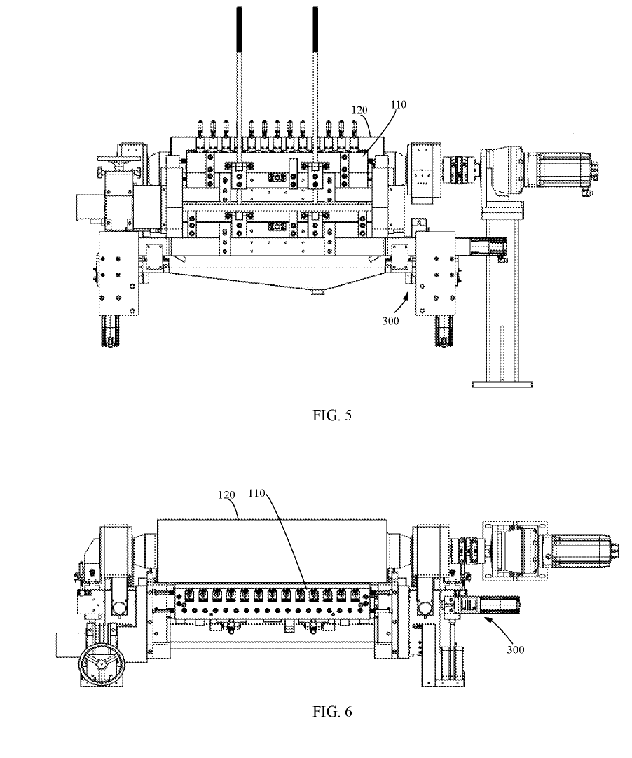

As shown in FIGS. 1 through 6, an embodiment of the present application provides a coating device, which includes a coating mechanism 100, a control module 200, a driving mechanism 300, and a monitoring assembly 400. Specifically:

The coating mechanism 100 includes a die head 110; the die head 110 is configured to apply a slurry, and the die head 110 is positioned at a target position according to the die head positioning method of the present application. The control module 200 is configured to transmit a motion command to the driving mechanism 300 based on a received preset spacing, and to receive monitoring data transmitted by the monitoring assembly 400. The driving mechanism 300 includes a servo motor 310, a lead screw assembly 320, and a built-in encoder 330; the servo motor 310 is configured to drive the lead screw assembly 320 according to the motion command; the lead screw assembly 320 is configured to drive the coating mechanism 100 to move reciprocally; and the built-in encoder 330 is configured to monitor the motion parameters of the servo motor 310 and provide feedback the motion parameters to the control module 200. The monitoring assembly 400 includes an external encoder 410; the external encoder 410 is configured to generate monitoring data. The monitoring data includes the target displacement and the real-time displacement of the die head 110.

Specifically, the control module 200 may be constituted by a Programmable Logic Controller (PLC) or a dedicated motion controller; which is not limited in herein. The control module 200 is capable of receiving preset parameters, such as coating thickness, speed, preset spacing, etc., input by an operator via a Human-Machine Interface (HMI); based on these parameters, it generates precise motion command and transmits the motion command to the driving mechanism 300.

Additionally, the control module 200 is also capable of receiving feedback signals from the drive mechanism 300 and the monitoring assembly 400. For example, the control module 200 receives data such as the rotational angle and speed of the servo motor 310, monitored by the built-in encoder 330 of the drive mechanism 300, and uses closed-loop control algorithms (e.g., PID control) to adjust the actions of the drive mechanism 300 in real time, ensuring the accuracy and stability of the coating process. The control module 200 receives feedback signals from the monitoring assembly 400 to control the drive mechanism 300 in real time, enabling the drive mechanism 300 to operate according to new motion commands.

Specifically, the driving mechanism 300 includes a servo motor 310, a lead screw assembly 320, and a built-in encoder 330. The servo motor 310 drives the lead screw assembly 320 to operate according to the motion commands transmitted by the control module 200. The lead screw assembly 320 converts the rotational motion of the servo motor 310 into linear motion, thereby driving the die head 110 of the coating mechanism 100 to move reciprocally along a predetermined trajectory. The built-in encoder 330 is mounted internally within the servo motor 310; the built-in encoder 330 serves to monitor motion parameters (such as rotational angle, speed, etc.) of the servo motor in real time and feeds these parameters back to the control module 200. By utilizing the feedback provided by the built-in encoder 330, the control module 200 can precisely regulate the motion of the servo motor 310, thereby ensuring that the real-time displacement of the die head 110 remains consistent with the preset spacing value.

Specifically, the coating mechanism 100 includes a die head 110. The die head 110 is configured to uniformly coat a slurry onto the surface of a substrate; for example, the positive or negative electrode plates of a battery. The die head 110 is connected to the lead screw assembly 320 and is capable of moving reciprocally along a linear guide rail according to the actuation of the driving mechanism 300, thereby moving towards or further away from the roller body 120 carried with the electrode plate. It is understood that, taking an extrusion-type coating device as an example, the spacing between the coating lip of the die head 110 and the roller body 120 constitutes the decisive factor influencing the thickness of the applied slurry coating. Consequently, the precise positional control of the die head 110 is a critical element of the coating device.

Specifically, the monitoring assembly 400 includes an external encoder 410, which is configured to monitor the position of the die head 110 in real time. The external encoder 410 can be a linear encoder configured to measure both the real-time displacement and the calibrated displacement of the die head 110. The linear encoder is mounted along the motion path of the coating mechanism 100, oriented parallel to the movement direction of the die head 110. By detecting encoded signals from a graduated scale, the linear encoder provides real-time feedback regarding the precise position of the die head 110. Based on feedback signals from the linear encoder, the control module 200 adjusts the operation of driving mechanism 300 to ensure that the real-time displacement of die head 110 aligns with a preset spacing value, thereby achieving high-precision coating control.

As illustrated by this embodiment, the coating device of the present application operates based on the collaborative interaction among the control module, the driving mechanism, the coating mechanism, and the monitoring assembly. Specifically, the absolute position memory of the built-in encoder and the absolute position memory of the external encoder undergo mutual verification; the dual-encoder system significantly enhances the reliability of positioning of the die head. This design ensures the precise positioning of the die head prior to slurry coating, thereby guaranteeing that the spacing between the coating lip of the die head and the roller body complies with the required coating thickness for the slurry.

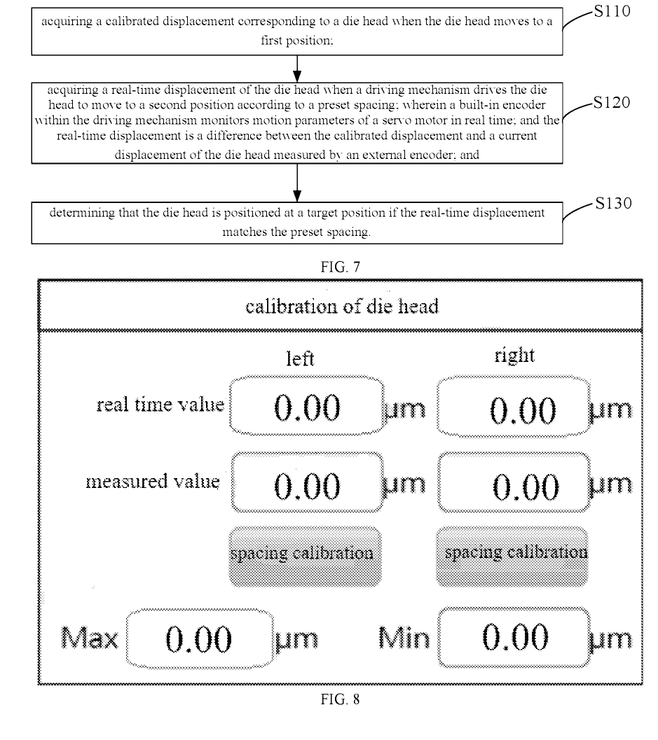

As shown in FIG. 7, the coating device of the present application is applied to the slurry coating of electrode sheets of the battery, an embodiment of the present application further provides a method for positioning the die head of the aforementioned coating device, which includes:

In a step S110, a calibrated displacement corresponding to a die head is acquired when the die head moves to a first position.

In this step, an initial position calibration is performed on the die head of the coating mechanism to acquire the corresponding calibrated displacement of the die head. In cases where the external encoder is, for example, a linear encoder, the movement range of the die head falls within the scale range of the linear encoder; specifically, the first position is a preset reference point located within the scale range of the linear encoder. Alternatively, the first position is any other random position within the scale range.

The coating device of the present application can further include a pneumatic cylinder driving assembly (not shown); the power output end of the pneumatic cylinder is connected to the die head. It is to be understood that the first position is a position located close to the roller body; in order to facilitate the rapid movement of the die head to the first position, in this step, a cylinder can be used to drive the die head, thereby enabling the die head to move rapidly over a large range in a short time. An operator can manually set an initial spacing S between the coating lip of the die head and the roller body; the control module sends a motion command to the pneumatic cylinder driving assembly based on the received value of the initial spacing S, so as to control the pneumatic cylinder to drive the die head to move according to the initial spacing S. When the die head reaches the first position, the spacing between the coating lip of the die head and the roller body is manually measured; if this measured spacing matches with the aforementioned preset initial spacing S, the initial calibration of the position of the die head is deemed complete. In other embodiments, the die head may alternatively be driven to the first position by the driving mechanism; which is not limited herein.

In order to ensure that the first position reached by the die head falls within the measurement range of the scale can be preset, in some embodiments, upper and lower limits for the initial spacing. This serves to prevent errors resulting from manually entered initial spacing values, thereby ensuring that the selected value of the initial spacing S remains within the upper and lower limits. As shown in FIG. 8, in order to enhance operational convenience for the user, in some embodiments, the coating mechanism further includes a display screen. The human-machine interface (HMI) on the display screen is configured to display at least a subset of the following parameters: the user-input initial spacing S (i.e., the measured value), the upper limit (Max) and lower limit (Min) for the initial spacing, and the real-time distance between the coating lip and the roller body (i.e., the actual value) in real time. Furthermore, the operator can also set the initial spacing S, and the upper and lower limits the initial spacing S, by accessing the corresponding parameter entry in the human-machine interface on the display screen, thereby improving operational convenience.

When the die head moves to the first position, the read head of the linear encoder captures a current initial displacement W of the die head, that is, W represents the initial displacement measured by the external encoder when the die head is located at the first position. By summing the obtained initial displacement W and the initial spacing S, the calibrated displacement L for the current position is derived: L = W + S. It should be understood that for each instance of position calibration, if the setting for the initial spacing S is changed, the specific first position reached by the die head will change accordingly, and the resulting calibrated displacement L is also changed. After the initialization calibration procedure is completed, the real-time spacing between the coating lip and the roller body (the actual value) is precisely matched with the initial spacing S (the measured value) entered by the user.

In the present application, the calibrated displacement L serves merely as an intermediate reference value required for subsequent positioning calculations and carries no intrinsic significance beyond that function. This design eliminates the need of fixing the calibration position of the die head, thereby preventing the accumulation of errors that can arise from repeated calibration, while simultaneously simplifying the operational complexity for the user and enhancing overall operational efficiency. It should be noted that the driving mechanism includes a series of mechanical structures, after the initialization calibration in this step is completed, for example, before each coating operation after powering on the system and assuming that the mechanical structures remain free from any loosening or displacement, the manual measurement of the spacing between the coating lip and the roller body will not generate any error after the driving mechanism has moved the die head to the preset initial spacing. If the manually measured result matches the displayed real-time value, it indicates that the device is functioning normally and does not require re-calibration, thereby enhancing operational efficiency.

In a step S120, when the driving mechanism moves the die head to a second position based on a preset spacing, the real-time displacement of the die head is acquired; specifically, a built-in encoder within the driving mechanism monitors the motion parameters of the servo motor in real time. The real-time displacement is defined as the difference between the calibrated displacement and the current displacement of the die head as measured by an external encoder.

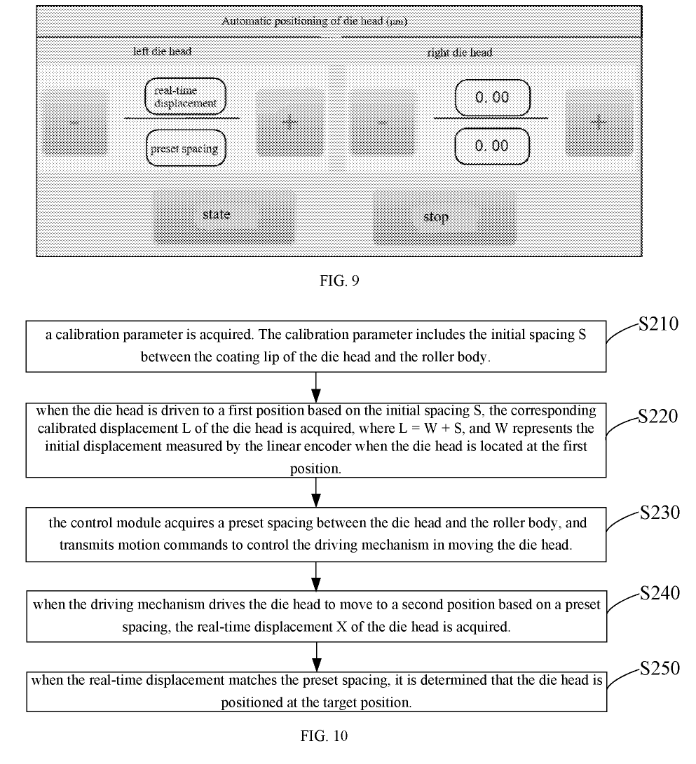

After the initial position calibration for the die head is completed, as shown in FIG. 9, an operator can use the human-machine interface (HMI) of the coating device to set a preset spacing between the coating lip and the roller body, based on the desired coating thickness. The PLC controller of the control module processes the received preset spacing to generate motion commands, and send the motion commands to the driving mechanism. The servo motor of the driving mechanism executes movements according to the motion parameters specified in the motion commands, thereby actuating the lead screw assembly and, in turn, driving the die head to move accordingly; throughout this process, the built-in encoder monitors the motion parameters of the servo motor in real time. It is understood that once the die head calibration is complete, the PLC controller acquires the absolute position of the calibrated die head, the absolute position is a value provided by the external encoder. Using the absolute position as a baseline, the PLC controller performs further calculations based on the preset spacing to determine the specific start and end motion parameters required for the subsequent drive operation of the servo motor; the built-in encoder monitors the servo motor and provides real-time feedback to the PLC controller. When the servo motor has completed the driving according to the motion commands, the die head reaches the second position, and the PLC controller then proceeds to calculate the real-time displacement of the die head. It is understandable that by using the high-precision built-in encoder that comes with the servo motor to calculate and control the movement of the motor, the motor can operate smoothly and respond quickly, thereby enabling the die head to precisely reach the target position, ensuring the accuracy of positioning and the response speed. Optionally, the HMI of the display screen can simultaneously show both the preset spacing and the real-time displacement, allowing the operator to intuitively monitor the current positioning status of the die head.

Furthermore, when the die head reaches the second position, the read head of the external encoder (i.e. a linear encoder) reads the current displacement Y corresponding to the current position. The real-time displacement X is the difference between the calibrated displacement L and the current displacement Y of the die head as measured by the external encoder; that is, X=L-Y. Based on this calculation, the display screen presents the real-time displacement X corresponding to the current position.

S130: If the real-time displacement matches the preset spacing, it is determined that the die head is positioned at the target position.

The value of the real-time displacement is compared against that of the preset spacing; if they match, it indicates that the die head has been positioned at the target position. Once the die head is situated at the target position, coating can be performed according to the desired coating thickness.

In some embodiments, when the deviation between the real-time displacement and the preset spacing is located with the preset range, it is determined that the real-time displacement matches the preset spacing. That is, the real-time displacement is exactly identical to the preset spacing, the real-time displacement is deemed to match the preset spacing. Alternatively, the real-time displacement may not be exactly identical to the preset spacing, that is, a numerical deviation exists between the real-time displacement and the preset spacing that falls within the preset range, which is deemed to constitute a match between the real-time displacement and the preset spacing. In some embodiments, when the real-time displacement falls within the range of the preset spacing ± 0.5 μm, which represents that the real-time displacement matches the preset spacing. The specific deviation value cited for this preset range herein serves merely as an illustrative example and is not intended to be limiting.

In some embodiments, when the real-time displacement does not match the preset spacing, the driving mechanism will continue to drive the die head to move based on the difference between the real-time displacement and the preset spacing until the die head is positioned at the target position. It is understandable that if the deviation between the real-time displacement and the preset spacing is significant, which indicates that the real-time displacement and the preset spacing do not match, the driving mechanism needs to continue moving to drive the die head to move. Specifically, during the movement of the die head, the external encoder sends the current displacement Y corresponding to the second position to the control module in real time. For example, the PLC controller calculates the current spacing between the real-time displacement of the die head and the preset spacing in real time, and then controls the driving mechanism to continue moving until the updated real-time displacement matches the preset spacing, and then determines that the die head is positioned at the target position.

In some specific embodiments, the external encoder is connected to the control module via a network communication link. For example, the linear encoder communicates with the control module via network to achieve data transmission at the millisecond level, enabling real-time monitoring and feedback of the actual position of the die head. Taking a certain sudden power outage scenario as an example, suppose the current displacement of the die head before the power outage was 100 μm, and after the power outage due to an accidental impact, the die head moved forward by 10 μm; based on the PLC controller receiving the latest data 100 μm sent by the linear encoder before the power outage, and the linear encoder records the absolute data change of the die head after the impact, the current displacement data after the power is restored will be updated accordingly to 90 μm. This design, by using the linear encoder and the built-in encoder as reference means for position verification, provides the system with additional die head position verification, enhancing the reliability of die head positioning. In the event of a power outage, the position memory function can be maintained. Even if the position of the external encoder (linear encoder) or the motor changes, the only data after power restoration can still be restored to the actual position, avoiding the problem of pulse loss caused by power outage in the traditional IO wiring method, and also avoiding the inefficient operation of re-calibrating the die head.

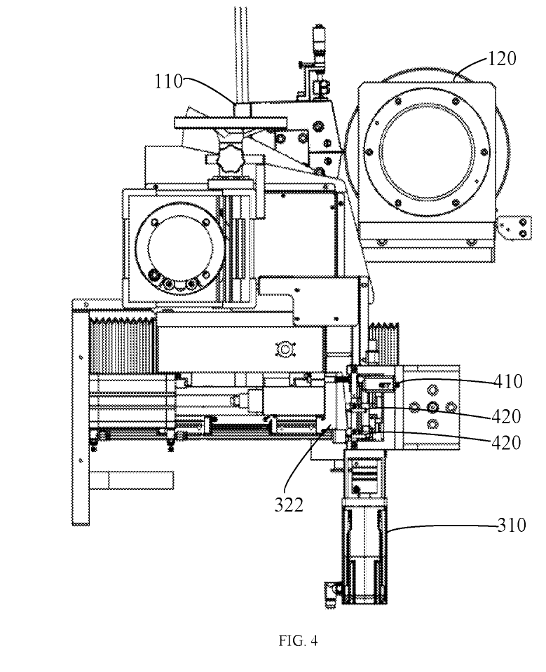

As shown in FIGS. 1 and 4, in other production scenarios, there are cases where operators manually adjust the position of the die head. For example, when adjusting the position of the die head by manually turning the motor, there is a risk of collision between the mechanism components, which may damage the equipment or affect production efficiency. In some embodiments, the monitoring assembly also includes a limiter. The limiter is used to monitor the movement range of the transmission mechanism in the driving mechanism. In some specific embodiments, the lead screw assembly includes a lead screw 321, upper slider 322 and lower slider 323; the upper slider 322 and the lower slider 323 move in different directions along the lead screw 321. It is understandable that the upper slider 322 is connected to the die head 110, driving the die head to move towards or move away from the roller body; the lower slider 323 moves axially along the lead screw 321 back and forth. Specifically, when the motor is manually operated, depending on different motor rotations, after being transmitted by the lead screw assembly, the die head will move towards or away from the roller body; correspondingly, the lower slider 323 moves synchronously along the axial direction of the lead screw 321 towards or away from the die head; if the movement range of the lower slider 323 is too large, the lower slider 323 will collide with the support where the die head is located. Based on this, by setting a limiter to limit the movement range of the lower slider, the movement range of the upper slider and the die head is also restricted. The limiter can be a limit sensor. The number of limit sensors can be one or two, for example, limit sensors are set respectively at the boundaries of the safe range. In some embodiments, the number of limit sensors is two, and the limit sensors include an upper limit sensor and a lower limit sensor, the upper limit sensor and the lower limit sensor are arranged axially on the lead screw, the spacing between the upper limit sensor and the lower limit sensor is greater than the preset spacing and less than the safe movement range of the lower slider. When the lower slider reaches the safe boundary, warning signals such as sound or light can be used to give an early warning to prevent the operator from moving the die head beyond the safe range, prevent accidental collisions, and improve operational safety; accordingly, the servo motor can be controlled to stop running in time, thereby preventing the lead screw assembly from continuing to run, and avoiding the slider from colliding with other components.

As illustrated by this example, in the die head positioning method of the present application, by adopting a dual encoder system, it calculates the position through the built-in encoder in the driving mechanism, such as the encoder of the servo motor, and then uses an external encoder, such as a linear encoder, as an auxiliary reference to achieve precise positioning of the die head. This dual confirmation mechanism improves the accuracy and reliability of the longitudinal position control of the die head. At the same time, the application of limiters further ensures the safety of the equipment and prevents the risk of equipment damage.

As shown in FIG. 10, the die head positioning method for a coating device according to an embodiment of the present application is further described below.

In a step S210, a calibration parameter is acquired. The calibration parameter includes the initial spacing S between the coating lip of the die head and the roller body.

The operator can input the initial spacing S through the human-machine interface of the coating device, and the control module will acquire the calibration parameter and send the motion commands to the driving mechanism for execution.

In a step S220, when the die head is driven to a first position based on the initial spacing S, the corresponding calibrated displacement L of the die head is acquired, where L = W + S, and W represents the initial displacement measured by the linear encoder when the die head is located at the first position.

In this embodiment, a pneumatic cylinder driving assembly moves the die head to the first position based on the initial spacing S. Meanwhile, the external encoder is operating in real time. Correspondingly, the external encoder acquires the initial displacement W of the die head at the current first position, and then calculates and acquires the calibrated displacement L. The calibrated displacement L is used as a reference value for subsequent calculations. After the calibration is completed, the human-machine interaction interface displays that the current real spacing (real-time value) of the die head is equal to the initial spacing S (measured value) input by the user.

In a step S230, the control module acquires a preset spacing between the die head and the roller body, and transmits motion commands to control the driving mechanism in moving the die head.

Based on the coating thickness of the slurry on the electrode sheet, the operator can input the preset spacing between the die head and the roller body through the human-machine interface. The control module converts the preset spacing into the motion commands for the driving mechanism. The motion commands can include parameters such as pulse count, speed and acceleration, which are used to control the movement of the servo motor. After receiving the motion commands, the servo motor starts to drive the lead screw assembly to rotate. The lead screw assembly converts the rotational motion of the servo motor into linear motion, driving the die head to move along the predetermined trajectory.

In a step S240, when the driving mechanism drives the die head to move to a second position based on a preset spacing, the real-time displacement X of the die head is acquired.

During the movement of the die head, the linear encoder continuously monitors the current displacement of the die head and feeds the current displacement back to the control module. Based on the calculation formula, the control module can calculate the real-time displacement (X = L - Y) of the die head when the die head reaches the second position. Y is a current displacement corresponding to the current position read by the read head of the linear encoder when the die head is at the second position. It should be noted that the determining step can be continuously carried out. That is, the second position can be any position before the die head reaches the target position. The linear encoder can continuously collect the current displacement Y of the die head, and the driving mechanism keeps driving the die head to move.

In a step S250, when the real-time displacement matches the preset spacing, it is determined that the die head is positioned at the target position.

When the control module determines that the real-time displacement matches the preset spacing, it confirms that the die head is positioned at the target position. Correspondingly, the driving mechanism stops operating. It is understandable that when the real-time displacement does not match the preset spacing, the driving mechanism continues to drive the die head to move based on the difference between the real-time displacement and the preset spacing until the die head is positioned at the target position.

During the movement of the die head, the linear encoder continuously monitors the real-time displacement of the die head and feeds back the signal to the control module. The control module uses the feedback signals from the linear encoder and the built-in encoder to further adjust the action of the servo motor, ensuring that the final real-time displacement of the die head is consistent with the preset spacing. Through closed-loop control, the coating device can achieve high-precision coating control, ensuring that the coating thickness and uniformity meet the process requirements.

It is understandable that during the coating process, if it is necessary to adjust the coating thickness, the operator can input a new preset spacing through the human-machine interface. The control module will recalculate the target displacement based on the new parameters and generate a new motion command to send to the driving mechanism. The servo motor will adjust its action according to the new motion command, causing the die head to move to the new target position. Through the real-time feedback from the built-in encoder and the linear encoder, the control module ensures that the displacement of the die head is consistent with the new preset spacing, thereby achieving precise and reliable dynamic adjustment. This dual-encoder positioning method eliminates the need for manual repeated positioning calibration of the die head, improving the coating accuracy and stability, and reducing the influence of human factors on the coating quality. Moreover, the dynamic positioning adjustment capability enables the coating device to adapt to different coating processes and substrate characteristics, improving the coating quality and production efficiency. Additionally, the simple operation interface allows the operator to input preset parameters through simple operations and monitor the coating process in real time, enhancing the operational convenience of the equipment and reducing the training costs for the operator.

An embodiment of the present application further provides an electronic device configured to function as the control module; the electronic device includes a memory and a processor. The processor can be a Central Processing Unit (CPU), or it can be another general-purpose processor, a Digital Signal Processor (DSP), an Application-Specific Integrated Circuit (ASIC), a Field-Programmable Gate Array (FPGA) or other programmable logic device, discrete gate or transistor logic device, discrete hardware component, and the like. A general-purpose processor can be a microprocessor, or the processor may be any conventional processor.

The memory can includes various types of storage units, such as system memory, Read-Only Memory (ROM), and a permanent storage device. Specifically, the ROM may store static data or instructions required by the processor or other modules of the computer. The permanent storage device may be a read-write storage device. The permanent storage device may be a non-volatile storage device that retains stored instructions and data even after the computer is powered off. In some embodiments, the permanent storage device utilizes a mass storage device (e.g., a magnetic or optical disk, or flash memory). In other embodiments, the permanent storage device can be a removable storage device (e.g., a floppy disk or an optical drive). The system memory can be a read-write storage device—specifically, a volatile read-write storage device, such as Dynamic Random-Access Memory (DRAM). The system memory may store some or all of the instructions and data required by the processor during runtime. Furthermore, the memory can include any combination of computer-readable storage media, including various types of semiconductor memory chips (e.g., DRAM, SRAM, SDRAM, flash memory, programmable read-only memory); magnetic disks and/or optical discs can also be utilized. In some embodiments, the memory can include readable and/or writable removable storage devices, such as compact discs (CDs), read-only digital versatile discs (e.g., DVD-ROM, dual-layer DVD-ROM), read-only Blu-ray discs, ultra-density optical discs, flash memory cards (e.g., SD cards, mini-SD cards, Micro-SD cards, etc.), magnetic floppy disks, and the like. Computer-readable storage media do not include carrier waves or transitory electronic signals transmitted via wireless or wired means.

A memory stores executable code; when this executable code is processed by a processor 1020, it enables the processor to perform part or all of the methods described herein.

Furthermore, the methods according to the present application may also be implemented as a computer program or a computer program product, which includes computer program code instructions configured to execute part or all of the steps of the aforementioned methods of the present application.

Alternatively, the present application may also be implemented as a computer-readable storage medium (or a non-transitory machine-readable storage medium or machine-readable storage medium) having stored thereon executable code (or a computer program or computer instruction code); when this executable code (or computer program or computer instruction code) is executed by a processor of an electronic device (such as a server), it causes the processor to perform part or all of the various steps of the aforementioned methods according to the present application.

The foregoing embodiments are provided solely to illustrate the technical solutions of the present application and are not intended to be limiting; although the present application has been described in detail with reference to the foregoing embodiments, those of ordinary skill in the art should understand that modifications may still be made to the technical solutions described in the aforementioned embodiments, or equivalent substitutions may be made to certain technical features therein. Such modifications or substitutions do not cause the corresponding technical solutions to depart from the spirit and scope of the technical solutions of the various embodiments of the present application, and are all intended to be encompassed within the scope of protection of the present application.

What is claimed is:

1. A die head positioning method for a coating device, comprising:
acquiring a calibrated displacement corresponding to a die head when the die head moves to a first position;
acquiring a real-time displacement of the die head when a driving mechanism drives the die head to move to a second position according to a preset spacing; wherein a built-in encoder within the driving mechanism monitors motion parameters of a servo motor in real time; and the real-time displacement is a difference between the calibrated displacement and a current displacement of the die head measured by an external encoder; and
determining that the die head is positioned at a target position if the real-time displacement matches the preset spacing.

2. The die head positioning method according to claim 1, wherein the calibrated displacement is defined as L = W + S, wherein W is an initial displacement measured by the external encoder when the die head is at the first position, and S is an initial spacing between a coating lip of the die head and a roller body.

3. The die head positioning method according to claim 1, wherein the method further comprises:
continuely driving, through the driving mechanism, the die head to move based on the difference between the real-time displacement and the preset spacing when the real-time displacement does not match the preset spacing, until the die head is positioned at the target position.

4. The die head positioning method according to claim 1, wherein the real-time displacement is determined to be matched with the preset spacing when a deviation between the real-time displacement and the preset spacing falls within a preset range.

5. A coating device, comprising a coating mechanism, a control module, a driving mechanism, and a monitoring assembly; wherein the coating mechanism comprises a die head, the die head is configured to apply a slurry, and the die head is positioned to a target position based on the die head positioning method according to claim 1;
the control module is configured to transmit a motion command to the driving mechanism based on a received preset spacing, and to receive monitoring data transmitted by the monitoring assembly;
the driving mechanism comprises a servo motor, a lead screw assembly, and a built-in encoder; the servo motor is configured to drive the lead screw assembly according to the motion command, the lead screw assembly is configured to drive the coating mechanism to move reciprocally, and the built-in encoder monitors a motion parameter of the servo motor and feeds the motion parameter back to the control module; and
the monitoring assembly comprises an external encoder, configured to generate the monitoring data, the monitoring data comprises a calibrated displacement and a real-time displacement of the die head.

6. The coating device according to claim 5, wherein the external encoder is in communication with the control module.

7. The coating device according to claim 5, wherein the monitoring assembly further comprises a limiter, the limiter is configured to monitor a movement range of a transmission component within the driving mechanism.

8. The coating device according to claim 5, wherein the built-in encoder is a rotary encoder, and the external encoder is a linear encoder.

9. The coating device according to claim 5, wherein the coating device further comprises a human-machine interface, configured to display the real-time displacement and to set the preset spacing.

10. A computer program product, comprising a computer program, wherein the computer program is configured to execute the die head positioning method for a coating device according to claim 1.

11. The die head positioning method according to claim 2, wherein the real-time displacement is determined to be matched with the preset spacing when a deviation between the real-time displacement and the preset spacing falls within a preset range.

12. The die head positioning method according to claim 3, wherein the real-time displacement is determined to be matched with the preset spacing when a deviation between the real-time displacement and the preset spacing falls within a preset range.

13. The coating device according to claim 6, wherein the coating device further comprises a human-machine interface, configured to display the real-time displacement and to set the preset spacing.

14. The coating device according to claim 7, wherein the coating device further comprises a human-machine interface, configured to display the real-time displacement and to set the preset spacing.

15. The coating device according to claim 8, wherein the coating device further comprises a human-machine interface, configured to display the real-time displacement and to set the preset spacing.
